(19) United States
(12) Patent Application Publication
(10) Pub. No.: US 2002/0021751 A1
(43) Pub. Date: Feb. 21, 2002

(54) System for documenting events

(76) Inventors: Luca Bolcioni, Bologna (IT); Roberto Guerrieri, Bologna (IT)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(21) Appl. No.: 09/828,536

(22) Filed: Apr. 6, 2001

(30) Foreign Application Priority Data
Apr. 10, 2000 (EP) 00830267.1

(51) Int. Cl. H04N 7/12

(52) U.S. Cl. 375/240.01; 375/240.26

(57) ABSTRACT

A system for documenting events is provided. The system includes a camera for acquiring images and producing a video signal, a memory for storing images based on the video signal, and a sensor coupled to the memory. The memory includes a first volatile memory and a second non-volatile memory. The images are stored in the volatile memory, and the sensor actives a transfer of the images from the volatile memory to the non-volatile memory. In a preferred embodiment, before activating the transfer of the images from the volatile memory to the non-volatile memory, the sensor waits a preset time in order to acquire further images in the volatile memory. Also provided is a method for documenting events.

### CROSS-REFERENCE TO RELATED APPLICATIONS

This application is based upon and claims priority from prior European Patent Application No. 00-830267.1, filed Apr. 10, 2000, the entire disclosure of which is herein incorporated by reference.

### BACKGROUND OF THE INVENTION

1. Field of the Invention

The present invention relates to digital signal processing, and more specifically to systems, methods, and integrated circuits for documenting events.

2. Description of Related Art

There are situations in which it is convenient to have documentation of the events that occur in order to determine the causes that have provoked the situation. It is still better if this documentation is a video that allows the easy and immediate control of the film. For instance, there are the events relative to car accidents, building fires, thefts, code infractions, and any other case in which it would be useful to have such documentation. Furthermore, in the cases exemplified above in which there could also be judicial and legal complications, it is also useful to have a verification of the identification and the authenticity of the video.

Patent application no. WO 99/62741 describes a system for picking up, analyzing, and storing information relative to the supervision of car accidents. The system, which is activated with the starting of the car, comprises a television camera for shooting the events outside the vehicle.

The digitized and stored images in a synchronized file have an identification of the vehicle, a time indicator, and other relative values related to the conditions of the vehicle. The file is coded and stored on a memory device of great capacity (e.g., hard disk) that is accessible by means of an access code.

However, a relevant event such as those mentioned above occurs in a very short fraction of time and therefore it is sufficient to record only some tens of seconds around the instant at which the event occurred.

### SUMMARY OF THE INVENTION

In view of these drawbacks, it is an object of the present invention to overcome the above-mentioned drawbacks and to provide a video recording that is of good quality, reliable, and certified at the occurrence of an event.

Another object of the present invention is to provide a system in which only some images around the instant of the occurrence of an event are recorded. In preferred embodiments, an opportune sensor is chosen and for each type of event that is desired to be documented, the instant of occurrence of the event is identified to cause the start of the recording of the images.

A further object of the present invention is to realize a system that is compact so that it can be used with limited room, that has a low current consumption so as to guarantee the system can perform its own functions in critical situations (e.g., by means of a battery).

One embodiment of the present invention provides a system for documenting events. The system includes a camera for acquiring images and producing a video signal, a memory for storing images based on the video signal, and a sensor coupled to the memory. The memory includes a first volatile memory and a second non-volatile memory. The images are stored in the volatile memory, and the sensor actives a transfer of the images from the volatile memory to the non-volatile memory. In a preferred embodiment, before activating the transfer of the images from the volatile memory to the non-volatile memory, the sensor waits a preset time in order to acquire further images in the volatile memory.

Another embodiment of the present invention provides a method for documenting events. According to the method, images are acquired with a camera, and digital data corresponding to the images is supplied. The digital data is stored in a first volatile memory, and a transfer of the digital data from the first volatile memory to a second non-volatile memory is activated in response to the occurrence of an external event. In one preferred method, the digital data is compressed before it is stored in the first memory.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 shows a block diagram of a system for documenting events in accordance with a preferred embodiment of the present invention; and

FIG. 2 shows a more detailed block diagram for one embodiment of the system shown in FIG. 1.

### DETAILED DESCRIPTION OF PREFERRED EMBODIMENTS

Preferred embodiments of the present invention will be described in detail hereinbelow with reference to the attached drawings.

Embodiments of the present invention provide systems, methods, and low consumption integrated circuits for documenting events. In particular, preferred embodiments provide a system for acquiring, processing, and recording a video sequence from a digital video camera. The system of the present invention is particularly suitable for installation in a car in order to shoot and store the instants of a car accident.

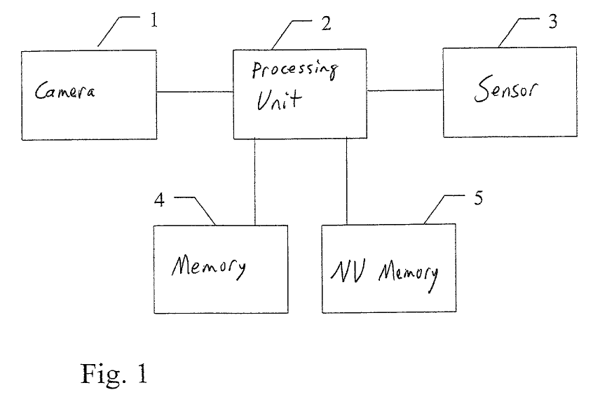

A simplified block diagram of a system for documenting events in accordance with a preferred embodiment of the present invention is shown in FIG. 1. The system comprises a television camera 1, a processing unit 2, a sensor 3, a volatile memory 4, and a non-volatile memory 5.

The operation of the above mentioned system is as follows. The television camera 1 acquires the images and continually sends them to the volatile memory 4 through the processing unit 2. At the filling of the memory 4, the older images will be replaced by newer ones. The sensor 3 is activated in response to an alteration of a physical quantity of the external environment, which could be of varied type in dependence of where the system is used and the type of event that it is desired to be recorded. When activated, the sensor activates a phase of permanent storage of the received images; that is, it activates the transfer of the stored images from the volatile memory 4 to the non-volatile memory 5. In one embodiment, these memories are each dimensioned so that they are able to store images for a duration of about 1 minute.

At the activation of the sensor 3, it is possible through proper programming to instantaneously activate the storage phase of the received image in the non-volatile memory 5, to wait some seconds before storing so as to acquire some further seconds of images, or even to begin at that instant to take images. Therefore, in relationship to the type of event that is desired to be recorded, it is possible to decide (by properly programming the processing unit 2) whether the images to record are those before, after, or around the event that has activated the sensor 3.

For instance, if the system is applied to a car for the recording of a video sequence relative to an accident, the sensor 3 could be the activation sensor of the passenger protection systems (e.g., air bags). During normal operation, the television camera 1 acquires the images and stores them continually in the volatile memory 4. In the case of an accident, the passenger protection systems are activated by the sensor 3, and therefore it activates a second manner of operation in which the phase of storage is not temporary any more (volatile) but permanent (non-volatile) so as to be readable later on.

In this way, the system of the present invention is able to furnish a reliable documentation of the instants immediately before, and in this case preferably also those immediately following, the accident (e.g., by waiting for some seconds after the activation of the sensor 3 before effecting the transfer of the data from the volatile memory 4 to the non-volatile memory 5).

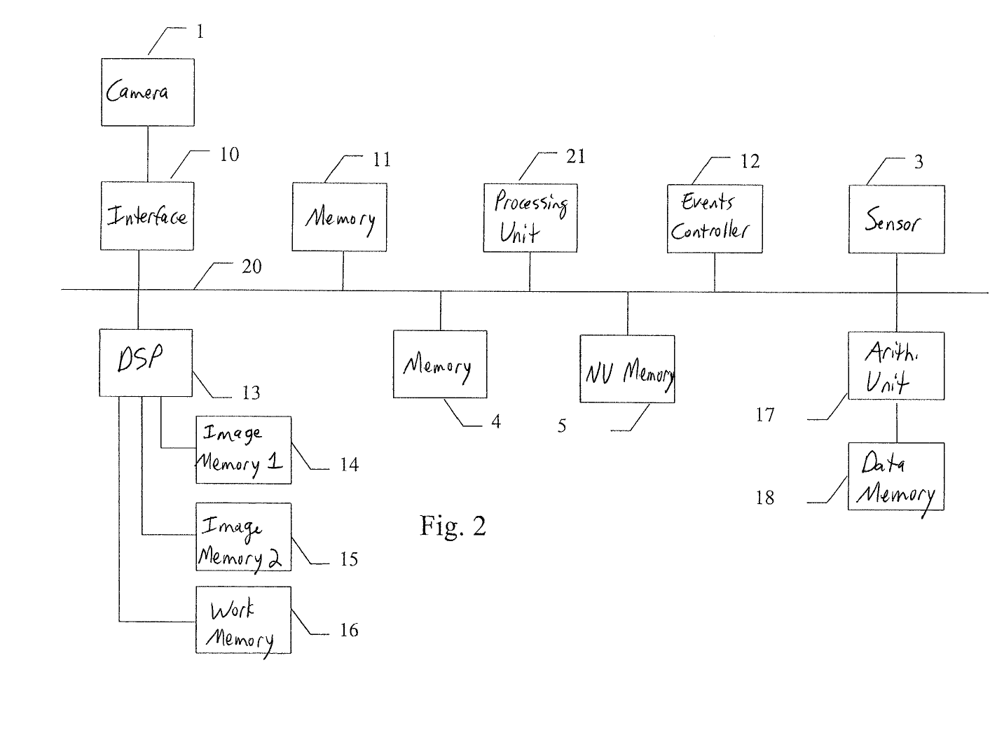

FIG. 2 is a block diagram showing in more detail the system of FIG. 1. As shown, to the television camera 1 there is associated an interface unit 10, to the processing unit 21 there is associated a memory 11 that contains the control program of the system which is run by the processing unit 21 itself, and to the sensor 3 there is associated a controller 12 of external and internal events (interrupt). Additionally, the system comprises: a digital signal processor 13 to which there is associated a first image memory 14, a second image memory 15, and a work memory 16; and a arithmetic processing unit 17 with arbitrary precision to which there is associated a data memory 18. All of the blocks of FIG. 2 communicate through an appropriate channel of transmission (e.g., bus) 20.

To reduce the quantity of information to store and at the same time to have a sufficient quality of the video, the video is preferred to have between 12 and 15 images a second in the QCIF format (Quarter Common Interchange Format with 144×176 pixels) in black and white. The video signal having the above characteristics is compressed by the digital signal processor 13 based on a programmable MAC (Multiply and Accumulate). The compression method used is preferably that written in Recommendation H263 of ITU-T (Line transmission of telephone signals: video coding for low bitrate communication). It is possible in further embodiments to use other methods of compression such as those written in the Standard ISO/IEC 13818-Information Technology-Generic codec of moving pictures and associated audio information-1966.

The legal value of the video could be obtained by means of a univocal association of an identifying number of the object (for example, the car license plate) to which the system is applied, and by the certification of the digital document that is carried out by the arithmetic processing unit 17 by means of a method of digital signature, such as of the DSA type (Digital Signature Algorithm) based on a system of double public and private key like that described in the book of B. Schneider entitled “Applied Cryptography” (John Wiley & Sons, 1994). In particular, the system knows the private (secret) key that is used for the digital signature. The people or predetermined associations are in possession of the public key, and can therefore certify to whom the film belongs by consulting a data bank of the keys used for the control of the signature. Thus they are able to attest to possible attempt to manipulate the images.

In this embodiment, the process starts with the receiving of the signal (digital) by the television camera 1. The succession of pixels is stored in a FIFO memory set in the interfacing unit 10. When this memory reaches a preset level of filling, the interfacing unit 10 sends a request to the first image memory 14 for the transfer of the pixels received up to that moment. After reaching a certain number of acquired lines and having this communicated to the processing unit 21 by the events controller 12, the processing unit 21 activates the digital signal processor 13 to compress the video signal. The DCT transformations (Discreet Cosine Transform), IDCT (Inverse Discreet Cosine Transform), quantization, and inverse quantification necessary to compress the video signal are realized by the proper programming of the digital signal processor 13. In this embodiment, the variable length codification procedure (VLC) is carried out by the processing unit 21.

The first image memory 14 is used to store an image, and the second image memory 15 is used to store the immediately preceding image. The digital signal processor 13 carries out the calculations (in collaboration with the processing unit 21) and sets the results in a third work memory 16. For applications of the present invention, a fixed bandwidth is not required and the increase of the image quality is not appreciable, so the loading and the processing time of the operations related to the searching of the movement vectors have been avoided assuming that a null movement vector furnishes the best compromise between complexity and quality.

To reduce the resource consumption of the system in the phase of processing the images, in this embodiment a particular memory hierarchy has been adopted. More specifically, a small working memory 16 is inserted in the same addressing space that is used for the image memories 14 and 15. Since the DSP 13 performs 80% of the reading and writing operations on this memory 16 of reduced dimensions, and considering that the system resource consumption depends on the capacitive load associated with the lines, the current consumption is reduced by the use of a memory of small dimensions. Besides, the use of a pipeline with two levels in the DSP 13 allows a further reduction in the energy consumed due to the commutation of the synchronism signal. In fact, since the DSP 13 is working for 75% of the whole time, the use of a deeper pipeline would cause an consumption increase due to the dividing elements of the various stages, without increasing the overall performance.

For each byte codified in conformity with the adopted compression method, two operations are performed. A first operation stores the data in the volatile memory 4, and a second operation prepares the data structure that will be used in the certification process.

At the filling of the volatile memory 4, it is necessary to replace the older images with the most recent ones. The compression of the video signal, in accordance with the selected method, is, in first approximation, calculating and recording the data that correspond to the difference between a starting image and the following and so on for the other following images. If at the receiving of the new images, during the storage of the compressed data the starting image is deleted, there would not any more exist the base data required to reconstruct the recorded images. In accordance with this embodiment of the present invention, the processing unit 21 has been properly programmed so as to insert in the volatile memory 4 a starting image for the following images at preset times (for instance, every 10 images). Accordingly, as a maximum, the preset number of images (10) would be lost in the case in which the recording begins with a difference-type image rather than with a starting image.

The arithmetical processing unit 17 carries out the certification operations.

Preferably, a method of digital signature of the DSA type is used as it is possible to prepare an elevated number of operations (pre-processing) in advance and to store them in (non-volatile) memory 11. In the phase of the turning on of the system, these data will be transferred into the (volatile) data memory 18. During the processing, the reading of these parameters is externally masked to avoid furnishing indications that could allow the recognition of the private key. Particularly, the externally-accessible terminals are isolated by a buffer circuit.

The digital signature is associated with each image. This means that the codification of a single image is considered like a bit sequence on which to perform the certification operation. The result (e.g., 320 bits) is inserted in the compressed video signal using an optional field that normal decoders discard. In the case of the H263 standard, this field is present at the level of the description of the image and is denominated PSPARE. Since the length of the PSPARE field is fixed at 8 bits, it is necessary to use 40 different PEI-PSPARE sequences (PEI of 1 bit length is used to enable the PSPARE field) with PEI fixed height for all 40 insertion operations of the signature value of the preceding image, before being able to proceed with the rest of the scheduled fields by the codification method introduced by a low value of PEI. To be able to realize the verification process of the signature, it is therefore necessary to extract by the compressed documentation this field and to proceed with the relative operations as described in the proposed reference.

Each program of each coprocessor of the system (processing unit 21, digital signal processor 13, and arithmetic processing unit 17) is able to modify the space of accessible memory to allow the carrying out of different operations simultaneously. To allow a correct processing and to be able to exploit in full the degree of parallelism at disposition, it is necessary to have a proper control scheme for the local memories. In this embodiment, a first level of synchronism is obtained by interrupts. In this way, external events can be made known to the program executing on the processing unit 21 so that it can adopt different solutions according to its own state and to the sequence of recognized external events.

The synchronism scheme among the elements belonging to the system of a single chip can use a different solution that makes use of explicit instructions of suspension (wait) of either the processing unit 21 or the DSP 13. Particularly, a protocol (handshake) allows the activation of the coprocessors by means of a starting signal (start) by the processing unit 21. Once this signal has been recognized, the individuated coprocessor (unit 13 or 17) notifies its busy state by means of a signal “busy” that stops the activity of the processing unit 21 in the case which requires the use the local resources assigned to the coprocessors. The processing unit 21 can again use such resources only after the liberation of the same by the coprocessor in activity; this event is signaled by the deactivation of the signal “busy” at the end of the execution of the procedure by the coprocessor unit.

In one embodiment of the system in accordance with the present invention, some of the described elements of the system have been realized on only one chip so as to allow a better realization and exploitation of the employed resources, either under a point of view of the performance or under a point of view of the costs as well as under a point of view of the reduction of the dimensions. In this embodiment, the integrated units on the same chip are: the processing unit 21 (for instance, an 8086); the memory 11 that contains the control program of the system (FLASH type 16 k×16 bit); the events controller 12 (of the type 8259); the image memories 14 and 15 (RAM memories having dimensions 25 k×8 able to store a single image in QCIF format); the RAM work memory 16 (1 k×16); and the RAM memory of data (2 k×16).

The units 10, 13, and 17 respectively for interfacing with the television camera, for processing, and for arithmetic processing are realized for this implementation on a single chip of the system. Externally, on a card on which there is also set the circuit described above, there are: the television camera 1 (for instance a PB-0100 of PhotoBit) for furnishing data and signals of synchronism in digital form; the sensor 3 (which, in accordance with the type of application could be anything such as an acceleration sensor to record accidents, a fire sensor, or a presence sensor for thefts or access control); the volatile memory 4 (a dynamic memory of 16 Mbit); and the non-volatile memory 5 (FLASH type memory by 16 Mbit such as the M29F160BT of STMicroelectronics).

It is possible to feed the whole system by means of an external power supply. In the alternative or in combination, it is possible to be fed with a battery. For instance, in the case of use of the system for the documentation of car accidents, the whole system could be fed by the battery of the car. However, the system is preferably also furnished with an auxiliary battery that is able to feed the system in the phase of transfer of the data by the volatile memory to the non-volatile memory, because in the case of an accident the main battery could be put out of order.

With the embodiment of the system described above, it is possible to store about 80 seconds of film. For the application in a car, it has been set that at the activation of the sensor 3 the system is able to acquire images for another 15 seconds before effecting the permanent recording of the images. In this way, there is obtained a recording of about 65 seconds before the accident and about 15 seconds after the accident.

In a further embodiment of the system of the present invention, all of the circuit elements (including the television camera 1, the sensor 3, the volatile memory 4, and the non-volatile memory 5) are realized on only a single chip to further reduce the dimensions and the costs. Eventually, the sensor 3 can be put outside the integrated circuit and set in the best place to be able to fulfill its function. In the alternative to the integration of all of the circuit elements on a single integrated circuit, it is possible to divide the system between more chips (multi-chips) and put them in a unique package or to use a double face micro-board in which the micro chip (or the micro chips) (in the package or not) and other possible components are assembled superficially.

The complete system composed of the circuits described above and the feeding battery is preferably placed in a suitable container to bear bumps of great intensity and to be fire resistant in order to avoid the destruction of the circuits. Further, in order to recover the recorded images, the reading of the data stored in the non-volatile memory 5 occurs through proper contacts that are predisposed on the card both to furnish the feeding battery and to receive the data, preferably in a serial form.

Because the control of the system is assigned to a programmable architecture (the program of the processing unit 21), there are provided many advantages among which is that of being able to vary the type of signature (in dependence for instance on the different countries in which the system is used), and being able to vary the performance of the system by simply modifying the control program. Moreover, when necessary, it also allows other values to be stored (e.g., in the PSPARE field) such as the date and activation time of the sensor, of each single image, and of environmental parameters to be documented. For instance in the case of car accidents, the data of instrument panel of the car (such as speed, ABS activation, and the like) and other possible data coming from other sensors (such as acceleration, temperature, and the like) can be stored for the occurrence, as well as location data derived from a GPS system.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A system for documenting events, said system comprising:
a camera for acquiring images and producing a video signal;
a memory for storing images based on the video signal, the memory including a first volatile memory and a second non-volatile memory; and
a sensor coupled to the memory,
wherein the images are stored in the volatile memory, and
the sensor actives a transfer of the images from the volatile memory to the non-volatile memory.

2. The system as defined in claim 1, wherein before activating the transfer of the images from the volatile memory to the non-volatile memory, the sensor waits a preset time in order to acquire further images in the volatile memory.

3. The system as defined in claim 1, further comprising a digital signal processor that compresses the video signal from the camera before in order to store the image in the memory in a compressed format.

4. The system as defined in claim 3, wherein the digital signal processor compresses the video signal in accordance with recommendation H263 of the ITU-T standard.

5. The system as defined in claim 1, further comprising an arithmetic processing unit that certifies the image using a digital signature method.

6. The system as defined in claim 1, wherein the video signal is a digital signal.

7. A method for documenting events, said method comprising the steps of:
acquiring images with a camera;
supplying digital data corresponding to the images;
storing the digital data in a first volatile memory; and
activating a transfer of the digital data from the first volatile memory to a second non-volatile memory in response to the occurrence of an external event.

8. The method as defined in claim 7, further comprising the step of compressing the digital data before storing it in the first memory.

9. The method as defined in claim 7, further comprising the step of certifying the digital data before storing it in the first memory through the use of a digital signature.

10. The method as defined in claim 7, further comprising the step of integrating the digital data with relative temporal data.

11. The method as defined in claim 7, further comprising the step of activating a sensor on the occurrence of the external event.

12. An integrated circuit for documenting events, said integrated circuit comprising:
a memory for storing images based on a video signal received from a camera, the memory including a first volatile memory and a second non-volatile memory; and
a sensor coupled to the memory,
wherein the images are stored in the volatile memory, and
the sensor actives a transfer of the images from the volatile memory to the non-volatile memory.

13. The integrated circuit as defined in claim 12, wherein before activating the transfer of the images from the volatile memory to the non-volatile memory, the sensor waits a preset time in order to acquire further images in the volatile memory.

14. The integrated circuit as defined in claim 12, further comprising a digital signal processor that compresses the video signal from the camera before in order to store the image in the memory in a compressed format.

15. The integrated circuit as defined in claim 12, further comprising an arithmetic processing unit that certifies the image using a digital signature method.

16. The integrated circuit as defined in claim 12, wherein the video signal is a digital signal.

17. A machine-readable medium encoded with a program for documenting events, said program containing instructions for performing the steps of:
acquiring images with a camera;
supplying digital data corresponding to the images;
storing the digital data in a first volatile memory; and
activating a transfer of the digital data from the first volatile memory to a second non-volatile memory in response to the occurrence of an external event.

18. The machine-readable medium as defined in claim 17, wherein said program further contains instructions for performing the step of compressing the digital data before storing it in the first memory.

19. The machine-readable medium as defined in claim 17, wherein said program further contains instructions for performing the step of certifying the digital data before storing it in the first memory through the use of a digital signature.

20. The machine-readable medium as defined in claim 17, wherein said program further contains instructions for performing the step of integrating the digital data with relative temporal data.

21. The machine-readable medium as defined in claim 17, wherein said program further contains instructions for performing the step of activating a sensor on the occurrence of the external event.
